(19) United States
(12) Patent Application Publication
(10) Pub. No.: US 2013/0088943 A1
(43) Pub. Date: Apr. 11, 2013

(54) OPEN-SIDE BRACELET WITH FRAME FOR WATCH

(71) Applicant: Teresa Teixeira, Stockton, CA (US)

(72) Inventor: Teresa Teixeira, Stockton, CA (US)

(21) Appl. No.: 12/983,305

(22) Filed: Jan. 1, 2011

(51) Int. Cl. G04B 45/00

(52) U.S. Cl. CPC G04B 45/0069
USPC 368/282

(57) ABSTRACT

A rigid bracelet has a side opening for sliding the bracelet onto the wrist and an open frame on one end of the bracelet for housing and displaying a watch face through the frame. The watch rests on a top center of the wrist with the side opening extending from the open frame to an opposite end of the frame positioned partway up a side of the wrist of the wearer but not visible when looking at the watch face. The watch works and the watch face are removable from the frame.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to jewelry bearing time pieces and in particular to a rigid bracelet having a side opening for sliding the bracelet onto the wrist and an open frame on one end of the bracelet for housing and displaying a watch face through the frame which rests on a top center of the wrist with the side opening extending from the open frame to an opposite end of the frame positioned partway up a side of the wrist of the wearer but not visible when looking at the watch face exposing a top and part of one side of the wrist on one side of the framed watch.

2. Description of Related Art Including Information Disclosed Under 37 CFR 1.97 and 1.98

Jewelry has been worn since the beginning of civilization and some form of jewelry body adornment is greatly sought after in most societies today. While wrist watches are made and worn with a few different styles of watch bands, the bands normally encircle the entire wrist or if they have an opening in the bracelet, the opening is usually centered on the bottom of the wrist with the watch face centered on the top of the wrist so that the band covers both sides of the wrist and the opening is not visible when looking at the watch face. The watch itself is normally the main feature and the watch band a secondary functional feature. The prior art lacks a stylish bracelet having a side opening so that only the watch face is centered on top of the wrist with no band extending or visible on one side of the watch face.

U.S. Pat. No. D480,653, issued Oct. 14, 2003 to Lo, is for the ornamental design for a bangle or cuff-style wrist watch with a side opening.

U.S. Pat. No. 2,189,096, issued Feb. 6, 1940 to Alonge, claims a watch bracelet which comprises a bracelet with an aperture for removably holding a watch.

U.S. Pat. No. 4,060,185, issued Nov. 29, 1977 to Kuroda, puts forth a band for a wrist-watch adapted to fit the arm of a user comprising a thin elastic metal plate having front and rear surfaces and first and second ends, a mounting hole through said metal plate adapted for mounting said wrist-watch behind said mounting hole with the back of the watch adjacent to said rear surface and the face of said watch protruding partly through said mounting hole, the ends of said metal plate forming a wrist encircling portion for the arm, and the metal plate being one piece, resilient material bonded to the rear surface of said wrist encircling portion, and said resilient material being wider than said wrist encircling portion whereby said resilient material protrudes outward beyond the side edges of said wrist encircling portion, and the front surface of said metal plate being exposed.

U.S. Pat. No. 3,968,643, issued Jul. 13, 1976 to Curtil, concerns a wristwatch case and wristlet assembly comprising a molded plastic wristwatch case which has a rear face with a flat peripheral shoulder and a protruding back having horns, which fits on a complementary central case-receiving part of a plastic wristlet also molded in a single piece.

U.S. Pat. No. 4,958,279, issued Sep. 18, 1990 to Proellochs, provides an assembly comprising a bracelet in special spring steel, adjustable by individual shaping on every wrist, and comprising a circular hole in its flat central part.

Three U.S. Pat. No. D511,978, issued Nov. 29, 2005, U.S. Pat. No. D513,997 issued Jan. 31, 2006, and U.S. Pat. No. D512,921 issued Dec. 20, 2005 all to Wilson, are for the ornamental designs for a watch and a portion of a watch.

U.S. Pat. No. 7,553,069, issued Jun. 30, 2009 to Gibbons, indicates a wristband including a strap, the strap being formed from an elastic textile, wherein the strap defines an orifice, the orifice configurable to being removably coupled to a housing member by elastically retracting around the housing member. In a further embodiment, the housing member further includes any of a timepiece, a computer, a music player, and a decorative element.

U.S. Pat. No. 3,492,809, issued Feb. 3, 1970 to Gisiger-Lusa, claims a wrist-band with an aperture to hold a watch movement.

U.S. Patent Application #20080310260, published Dec. 18, 2008 by Segal, claims a modular watchcase having a substantially hollow protective casing configured to hold a watch mechanism allowing passage for at least one watch control projection and a frame member configured to surround the casing and having anchor elements for the attachment of a watch strap. The frame member allows passage for the watch control projection, and a bezel ring is attachable to the enclosure without need of tools for easy interchangeability of the frame member.

U.S. Patent Application #20070253290, published Nov. 1, 2007 by Aire, describes a modular wristwatch including a watch case assembly and a removable watch movement assembly. The watch case assembly includes an articulating bezel having a first bezel portion pivotally connected to a second bezel portion that enables the first bezel portion to move between open and closed configurations, allowing the watch movement assembly to be moved into and out from the watch case assembly.

U.S. Patent Application #20060171261, published Aug. 3, 2006 by Ruchonnet, discloses a wristwatch which is rendered reversible and interchangeable relative to a holder whereby various wristwatch movements can be fitted to a single strap, meaning that the watch can be replaced or reversed quickly without opening the strap or case. This aim is achieved by means of a device whereby an object such as a watch case is rendered reversible and interchangeable in a supporting element that is open on one side so that the reversible and interchangeable object can be inserted or withdrawn through said side opening, characterized in that said side opening is sealed by a portion of the reversible and interchangeable object that fits snugly onto the open side of the supporting element, thereby locking same. The device comprises retaining means for retaining the reversible and interchangeable object within the supporting element.

U.S. Pat. No. 5,657,298, issued Aug. 12, 1997 to Choay, provides a watch with interchangeable elements. The watch comprises a case containing a movement and a dial, a strap to secure the case to the wrist as well as an assembly cover adapted to be secured to the case and the strap. The assembly cover is provided with reception recesses for the strap and a snap-in connection for the case. The case in use masks the recesses of the strap. The assembly cover comprises on opposite sides of its internal surface two side walls defining openings permitting the passage of the strap.

U.S. Pat. No. 7,703,974, issued Apr. 27, 2010 to Bouille, shows a reversible watch comprising at least one reversible and interchangeable dual dial element including a cavity and a removable projecting fixing element integral with the bracelet or other support to be inserted axially parallel or not and to be moved in parallel with the element to the cavity up to a stop position and brought by rotation into its fixing position. The removable fixing element can be made in different embodiments desired by a user. The device comprises a cavity in the middles wherein is housed the base of a pivot of the removable fixing element which is integral with one end of the bracelet, whereby a rotational motion is imparted to a watch case and to its bracelet, independently of each other, so as to provide a watch with interchangeable double dial and a double-sided bracelet.

U.S. Pat. No. 7,771,112, issued Aug. 10, 2010 to Morgan, discloses wrist-borne structures (such as watches) which include: (a) a wrist band assembly defining a recess and a first aperture; (b) an electronic or mechanical device assembly having a first control element positioned in the recess so as to be accessible at the first aperture; and (c) a first user interaction element engaged with the first control element via the first aperture.

U.S. Pat. No. 4,627,738, issued Dec. 9, 1986 to Kao, illustrates a watchcase and watchframe suitable for mating and unmating one with the other by the use of a sealing means suitable for slidably translating the case within the frame and providing a substantially contiguous fit of the case within the frame.

U.S. Pat. No. 2,219,277, issued Oct. 22, 1940 to Kaufmann, is for a bracelet which detachably and interchangeably receives watch casings.

What is needed is a stylish bracelet having a side opening so that only the watch face is centered on top of the wrist with no band extending or visible on one side of the watch face to produce a similar visual effect of a dress which is strapless on one side with no apparent support.

### BRIEF SUMMARY OF THE INVENTION

An object of the present invention is to provide a stylish bracelet having a side opening so that only the watch face is centered on top of the wrist with no band extending or visible on one side of the watch face to produce a similar visual effect of a dress which is strapless on one side with no apparent support.

Another object of the present invention is to provide a bracelet having a side opening and a watch receiving frame which receives replaceable watches in the frame and/or replaceable watch faces to vary the appearance and style of the bracelet watch.

In brief, the present invention provides a stylish rigid metal bracelet or bracelet of other material such as plastic or other material which has a side opening for sliding the bracelet onto the wrist of the wearer and an open frame on one end of the bracelet for housing and displaying a watch face through the frame which frame and watch face rests on a top center of the wrist with the side opening extending from the open frame to an opposite end of the frame positioned partway up a side of the wrist of the wearer but not visible when looking at the watch face.

An advantage of the present invention is that it easy to put onto and take off of the wrist of the wearer.

Another advantage of the present invention is that it is an attractive bracelet as well as a watch.

One more advantage of the present invention is that the watch itself and/or the watch face may be removed to be replaced with watches and watch faces having different functions and applications and different appearances and styles.

An additional advantage of the present invention is that the bracelet leaves a portion of the wrist of the wearer exposed.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the open-sided bracelet jewelry watch of the present invention showing the face of the watch in the end frame of the bracelet;

FIG. 2 is a perspective view of the open-sided bracelet jewelry watch of FIG. 1 showing the back of the watch in the end frame of the bracelet;

FIG. 3 is a front watch face view of the open-sided bracelet jewelry watch of the present invention showing the face of the watch in the end frame of the bracelet;

FIG. 4 is a back bracelet view of the open-sided bracelet jewelry watch of the present invention showing a portion of the back of the watch in the end frame of the bracelet;

FIG. 5 is a top edge view of the open-sided bracelet jewelry watch of the present invention showing the top of the partially encircling bracelet;

FIG. 6 is a bottom edge view of the open-sided bracelet jewelry watch of the present invention showing the bottom of the partially encircling bracelet;

FIG. 7 is a front watch face view of the open-sided bracelet jewelry watch of the present invention showing the bracelet worn on the wrist of a user with the watch face visible in the frame and showing a portion of the bracelet on one side and a portion of the top of the wrist and a portion of the side of the wrist exposed through the side opening in the bracelet on the other side of the watch face;

FIG. 8 is a perspective view of the open-sided bracelet jewelry watch of the present invention showing the face of the watch removed from the front of the watch in the end frame of the bracelet;

FIG. 9 is a perspective view of the open-sided bracelet jewelry watch of the present invention showing the entire watch removed from the back of the end frame of the bracelet.

### DETAILED DESCRIPTION OF THE INVENTION

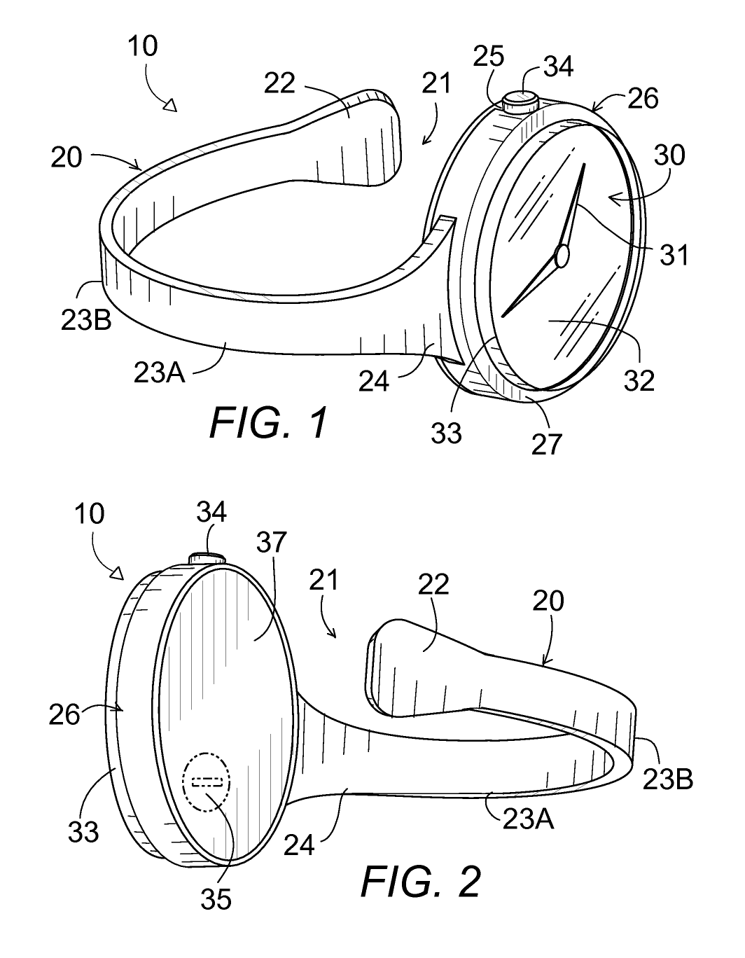

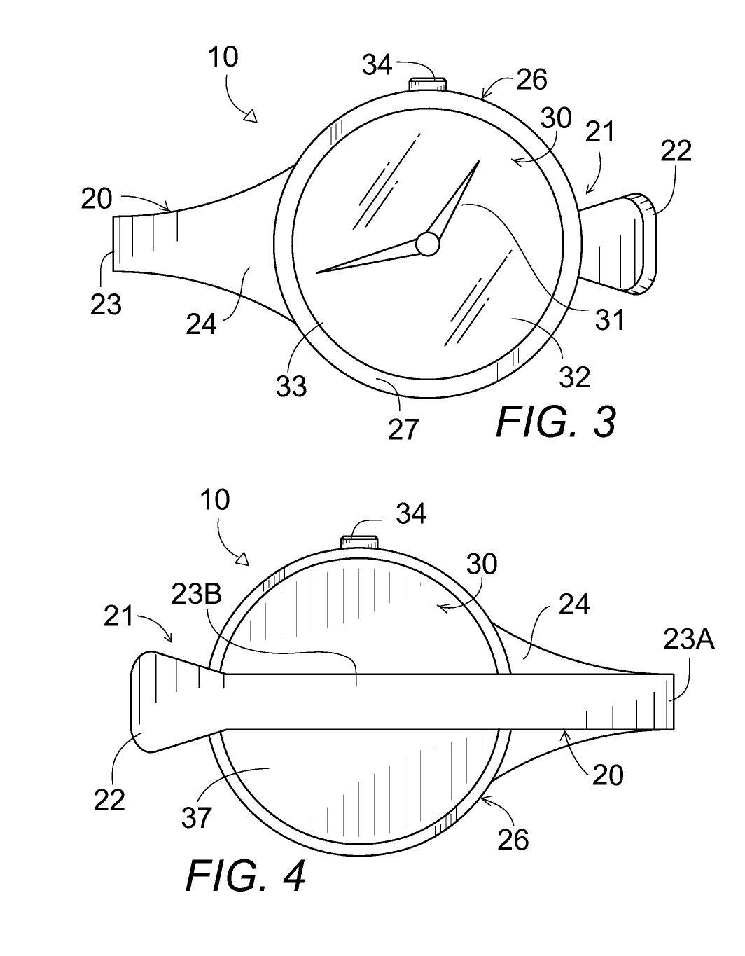

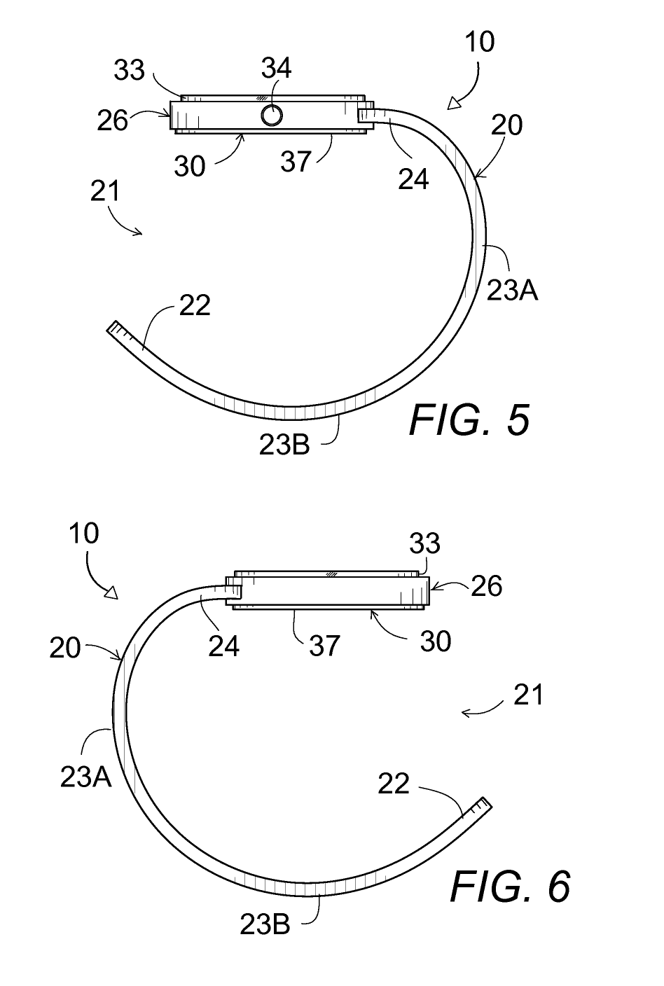

In FIGS. 1-9, a bracelet watch device 10 has a side opening 21 and interchangeable watch elements 30 fitting removably in a watch receiving frame 26 at one end of the bracelet.

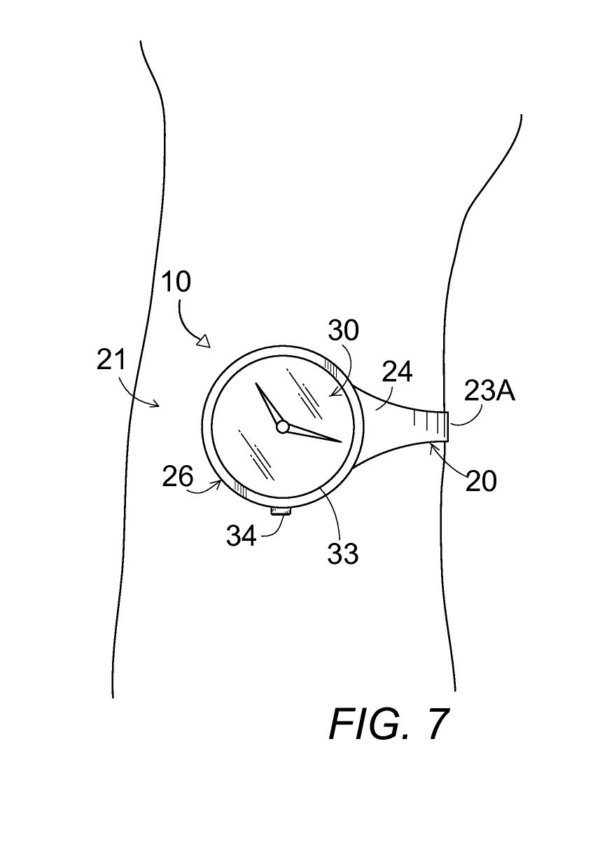

The bracelet comprises a rigid bracelet 20 encircling a portion of a wrist of a wearer, as shown in FIG. 7, leaving an exposed portion of the wrist from the centrally positioned watch face to one side of the wrist. A watch receiving frame 26 is built into one end of the bracelet and comprises means for retaining the watch in the frame. The frame 26 and the framed watch face 32 are positioned over a center of a top portion of the wrist. The bracelet further comprises a rigid arm having a partial top arm portion 24 extending from the frame 26 to a first side of the wrist of the wearer, a side arm portion 23A extending around the first side of the wrist, a bottom arm portion 23B extending across a bottom portion of the wrist, and an end arm portion 22 extending partway up a second side of the wrist leaving a bracelet side opening 21 between the frame 26 and the end arm portion 22, so that the bracelet slides onto the wrist through the bracelet side opening 21 from the first side of the wrist until the first side of the wrist contacts the side arm portion 23A of the bracelet and the with the end arm portion 22 extending partway up the second side of the wrist to hold the bracelet on the wrist of the wearer.

The watch 30 fits into the frame 26 with a face 32 of the watch visible through a transparent face cover 33 through the front of the frame 26, as shown in FIG. 1, and a back of the watch 37 accessible through a back of the frame 26, as shown in FIG. 2. At least a portion of the watch 30 is replaceable, thereby forming a bracelet watch device 10 with a side opening 21 and interchangeable watch elements.

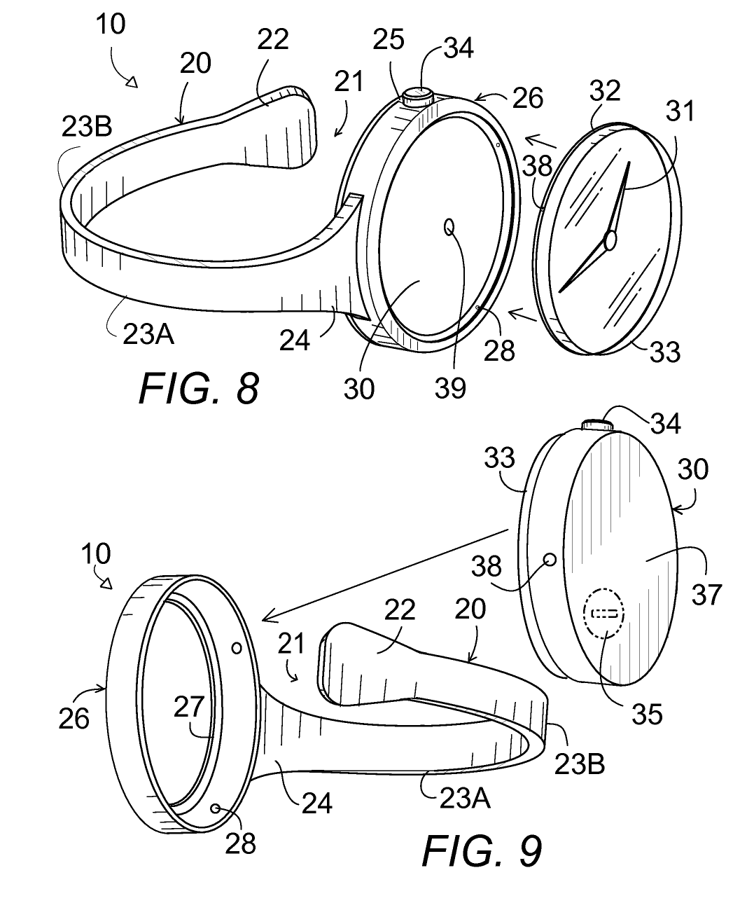

In FIG. 9, the watch 30 is inserted through the back of the frame 26 and the means for retaining the watch in the frame comprises a ridge 27 extending from the front of frame into a portion of the front frame opening to prevent the watch from passing through the front frame opening and at least one mating pair of snap engaging elements 28 and 38 between the watch and an interior surface of the frame to retain the watch removably therein with a snap fit, so that the watch 30 is removable and replaceable in the frame 26 to allow for a variety of types and styles and colors of watches. The snap engaging elements 28 and 38 may be mating protrusions and detents for connecting the watch 30 in FIG. 9 and for connecting the watch face 32 in FIG. 8.

The watch 30 may be permanently attached to the frame 26 by soldering or welding the watch 30 to the frame 26 for a permanent watch 30 in the watch bracelet 20. In FIG. 8, a permanently attached watch 30 has a removable face 32 and watch hands 31 and transparent cover 33 to allow changing just the face 32 of the watch in the bracelet 26 for various effects and styles and colors. A connecting element 39 in the center of the watch 30 removably receives a mechanism from the center of the hands 31 to connect the hands with the operating mechanism of the watch. It may be a shaft and gear mechanism.

In FIG. 1, the watch 30 may have a top knob 34 for adjusting the time on the watch and the frame 26 have a notch 25 in the top of the frame for receiving the top knob of the watch therein. For a wind-up watch, the top knob 34 is also used for winding the watch, so that the top of the frame at the notch is structured with an extra recess to permit the knob to be lifted up for adjusting the time and down for winding the watch.

The watch 30 may be a battery powered watch 30 having the battery compartment 35 in the back 37 so that the back opening of the frame allows a wearer to replace the battery in the watch through the back of the frame, as shown in FIGS. 2 and 9.

A wide variety of types of materials may be used from precious metals and expensive elegant watch components to stainless steel to synthetic material, such as plastic, and colorful bracelets and watch components to suit a variety of types of users including children. While the watch shown has hands a mechanical movement controlled by the watch knob, it is understood that it may be a digital watch.

The bracelet is preferably black finished metal and the face black with white hands to create a desired design look. The bracelet watch slips over the wrist through the side opening in the bracelet.

It is understood that the preceding description is given merely by way of illustration and not in limitation of the invention and that various modifications may be made thereto without departing from the spirit of the invention as claimed.

What is claimed is:

1. A bracelet watch device with a side opening and interchangeable watch elements, the device comprising:
a bracelet comprising a rigid bracelet encircling a portion of a wrist of a wearer, a watch receiving frame built into one end of the bracelet, means for retaining a watch in the frame, the frame positioned over a center of a top portion of the wrist; the bracelet further comprising a rigid arm having a partial top arm portion extending from the frame to a first side of the wrist, a side arm portion extending around the first side of the wrist, a bottom arm portion extending across a bottom portion of the wrist, and an end arm portion extending partway up a second side of the wrist leaving a bracelet side opening between the frame and the end arm portion, so that the bracelet slides onto the wrist through the bracelet side opening from the first side of the wrist until the first side of the wrist contacts the side arm portion of the bracelet and the with the end arm portion extending partway up the second side of the wrist to hold the bracelet on the wrist of the wearer;
a watch fitting into the frame with a face of the watch visible through a front of the frame and a back of the watch accessible through a back of the frame, at least a portion of the watch being replaceable, thereby forming a bracelet watch device with a side opening and interchangeable watch elements.

2. The device of claim 1 wherein the frame has a back opening to receive the watch inserted through the back of the frame and the means for retaining the watch in the frame comprises a peripheral ridge extending from the front of frame inwardly into a portion of the front frame opening to prevent the watch from passing through the front frame opening and at least one mating pair of snap engaging elements between the watch and an interior surface of the frame to retain the watch removably therein with a snap fit, so that the watch is removable and replaceable in the frame.

3. The device of claim 1 wherein at least a peripheral portion the watch and the band are each fabricated of metal and the watch is soldered to the frame for a permanent watch in the watch bracelet.

4. The device of claim 1 wherein the watch has a top knob for adjusting the time on the watch and the frame has a notch in the top of the frame for receiving the top knob of the watch therein.

5. The device of claim 4 wherein the watch is a wind-up watch and the top knob is also used for winding the watch, so that the top of the frame at the notch is structured to permit the knob to be lifted up for adjusting the time and down for winding the watch.

6. The device of claim 1 wherein the face of the watch is removable and replaceable for changing the watch face type.

7. The device of claim 1 wherein the watch is a battery powered watch having the battery compartment in the back so that the back opening of the frame allows a wearer to replace the battery in the watch through the back of the frame.
